(19) United States
(12) Patent Application Publication
(10) Pub. No.: US 2025/0272059 A1
(43) Pub. Date: Aug. 28, 2025

(54) PROGRAM GENERATION METHOD AND RELATED DEVICE

(71) Applicant: Beijing Zitiao Network Technology Co., Ltd., Beijing (CN)

(72) Inventors: Chunsheng TAO, Beijing (CN); Jifei Li, Beijing (CN)

(21) Appl. No.: 19/060,476

(22) Filed: Feb. 21, 2025

(30) Foreign Application Priority Data
Feb. 23, 2024 (CN) 202410205312.X

(51) Int. Cl. G06F 8/30

(52) U.S. Cl. CPC G06F 8/30

(57) ABSTRACT

The present disclosure provides a program generation method and related device. The method includes: acquiring a target component, where the target component includes a first-type component based on a first program platform and a second-type component based on a second program platform; generating a first-type file based on the first-type component, and generating a second-type file based on the second-type component; and fusing the first-type file and the second-type file to generate a target program.

### CROSS-REFERENCE TO RELATED APPLICATION

The present application is based on and claims priority to Chinese Patent Application No. 202410205312.X filed on Feb. 23, 2024, the disclosure of which is incorporated by reference herein in its entirety.

### TECHNICAL FIELD

The present disclosure relates to the field of computer technologies, and in particular, to a program generation method and related device.

### BACKGROUND

Traditional program development usually requires users to possess profound program expertise, which increases the barrier to entry and learning costs of the user. In addition, due to the need to manually write a large amount of code, the program development process is often time-consuming and labor-intensive. Although some current program development platforms reduce the development barrier, they usually limit the choice of technology stack.

### SUMMARY

In a first aspect, the present disclosure provides a program generation method, including:
acquiring a target component, where the target component includes a first-type component based on a first program platform and a second-type component based on a second program platform;
generating a first-type file based on the first-type component, and generating a second-type file based on the second-type component; and
fusing the first-type file and the second-type file to generate a target program.

In a second aspect, the present disclosure provides a program generation apparatus, including:
an acquisition module, configured to acquire a target component, where the target component includes a first-type component based on a first program platform and a second-type component based on a second program platform;
a first-type file module, configured to generate a first-type file based on the first-type component;
a second-type file module, configured to generate a second-type file based on the second-type component; and
a program generation module, configured to fuse the first-type file and the second-type file to generate a target program.

In a third aspect, the present disclosure provides an electronic device, including one or more processors, a memory, and one or more programs, where the one or more programs are stored in the memory and executed by the one or more processors, and the program includes instructions for executing the method according to the first aspect.

In a fourth aspect, the present disclosure provides a non-transitory computer-readable storage medium including a computer program, where the computer program, when executed by one or more processors, causes the processor to execute the method according to the first aspect.

In a fifth aspect, the present disclosure provides a computer program product including computer program instructions, where the computer program instructions, when executed on a computer, cause the computer to execute the method according to the first aspect.

### BRIEF DESCRIPTION OF THE DRAWINGS

In order to more clearly describe the technical solutions in the present disclosure or in the related art, the drawings required in the description of the embodiments or the related art will be briefly introduced below. Obviously, the drawings in the following description are only some embodiments of the present disclosure. For those of ordinary skill in the art, other drawings can be obtained based on these drawings without paying any creative effort.

FIG. 1 is a schematic diagram of a program generation architecture according to an embodiment of the present disclosure.

FIG. 2 is a schematic diagram of a hardware structure of an exemplary electronic device according to an embodiment of the present disclosure.

FIG. 3 is a schematic flowchart of a program generation method according to an embodiment of the present disclosure.

FIG. 4 is a schematic diagram of a program generation method according to an embodiment of the present disclosure.

FIG. 5 is a schematic diagram of updating a target program according to an embodiment of the present disclosure.

FIG. 6 is a schematic diagram of a program generation apparatus according to an embodiment of the present disclosure.

### DETAILED DESCRIPTION

In order to make the objectives, technical solutions, and advantages of the present disclosure clearer, the following further describes the present disclosure in detail with reference to the drawings and specific embodiments.

It should be noted that, unless otherwise defined, the technical terms or scientific terms used in the embodiments of the present disclosure should have the general meaning understood by those of ordinary skill in the art to which the present disclosure belongs. “First”, “second” and similar words used in the embodiments of the present disclosure do not represent any order, quantity or importance, but are only used to distinguish different components. Words such as “including” or “including” mean that the element or object appearing in front of the word covers the element or object listed after the word and its equivalent, without excluding other elements or objects. Words such as “connect” or “connected” are not limited to physical or mechanical connection, but may include electrical connection, whether direct or indirect. “Up”, “down”, “left”, “right” and the like are only used to indicate the relative position relationship, and when the absolute position of the described object changes, the relative position relationship may also change accordingly.

It can be understood that, before using the technical solutions disclosed in the embodiments of the present disclosure, users should be informed of the type, scope of use, use scenarios and the like of personal information involved in the present disclosure in an appropriate manner in accordance with relevant laws and regulations, and the authorization of users should be obtained.

For example, in response to receiving an active request from a user, prompt information is sent to the user to clearly inform the user that the operation he/she requests to perform will require the acquisition and use of personal information of the user. Thus, the user can independently choose whether to provide personal information to software or hardware such as an electronic device, an application, a server, or a storage medium that performs the operations of the technical solutions of the present disclosure, according to the prompt information.

As an optional but non-limiting implementation, a manner of sending prompt information to the user in response to receiving the active request from the user may be, for example, a pop-up window, and the prompt information may be presented in the form of text in the pop-up window. In addition, the pop-up window may also carry a selection control for the user to select “agree” or “disagree” to provide personal information to the electronic device.

It can be understood that the above process of notifying and acquiring user authorization is only illustrative, and does not constitute a limitation on the implementations of the present disclosure, and other methods that meet relevant laws and regulations can also be applied to the implementations of the present disclosure.

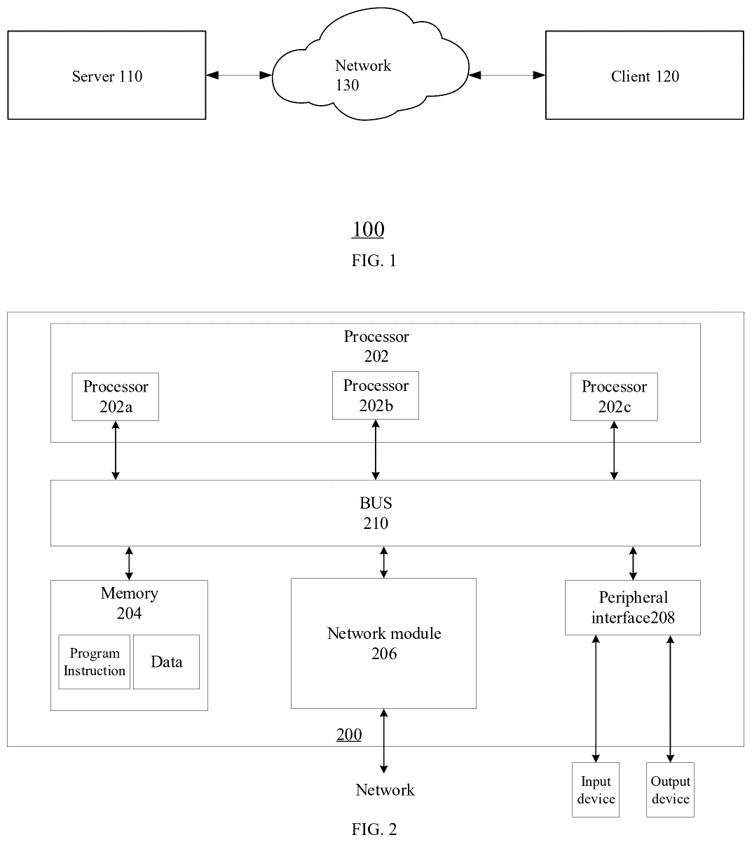

FIG. 1 shows a schematic diagram of a program generation architecture according to an embodiment of the present disclosure. Referring to FIG. 1, the program generation architecture 100 may include a server 110, a terminal 120, and a network 130 that provides communication links. The server 110 and the terminal 120 may be connected through a wired or wireless network 130. The server 110 may be an independent physical server, or a server cluster or distributed system composed of multiple physical servers, or a cloud server that provides basic cloud computing services such as cloud services, cloud databases, cloud computing, cloud functions, cloud storage, network services, cloud communication, middleware services, security services, CDN, etc.

The terminal 120 may be implemented in hardware or software. For example, when the terminal 120 is implemented in hardware, it may be various electronic devices with a display screen and supporting page display, including but not limited to smart phones, tablet computers, e-book readers, laptop portable computers, desktop computers, etc. When the terminal 120 is implemented in software, it may be installed in the above-listed electronic devices; it may be implemented as multiple software or software modules (for example, software or software modules used to provide distributed services), or may be implemented as a single software or software module, which is not specifically limited here.

It should be noted that the program generation method provided in the embodiments of the present application may be executed by the terminal 120, or may be executed by the server 110. It should be understood that the number of terminals, networks, and servers in FIG. 1 is only schematic, and is not intended to limit them. According to implementation needs, there may be any number of terminals, networks, and servers.

FIG. 2 shows a schematic diagram of a hardware structure of an exemplary electronic device 200 provided by an embodiment of the present disclosure. As shown in FIG. 2, the electronic device 200 may include: a processor 202, a memory 204, a network module 206, a peripheral interface 208, and a bus 210. The processor 202, the memory 204, the network module 206, and the peripheral interface 208 implement communication connection between each other inside the electronic device 200 through the bus 210.

The processor 202 may be a central processing unit (Central Processing Unit, CPU), a program generator, a neural network processor (NPU), a microcontroller (MCU), a programmable logic device, a digital signal processor (DSP), an application specific integrated circuit (Application Specific Integrated Circuit, ASIC), or one or more integrated circuits. The processor 202 may be used to perform functions related to the technologies described in the present disclosure. In some embodiments, the processor 202 may further include multiple processors integrated into a single logical component. For example, as shown in FIG. 2, the processor 202 may include multiple processors 202a, 202b, and 202c.

The memory 204 may be configured to store data (for example, instructions, computer code, etc.). As shown in FIG. 2, the data stored in the memory 204 may include program instructions (for example, program instructions for implementing the program generation method of the embodiments of the present disclosure) and data to be processed (for example, the memory may store configuration files of other modules, etc.). The processor 202 can also access the program instructions and data stored in the memory 204, and execute the program instructions to operate on data to be processed. The memory 204 may include a volatile memory or a non-volatile memory. In some embodiments, the memory 204 may include a random access memory (RAM), a read-only memory (ROM), an optical disk, a magnetic disk, a hard disk, a solid-state disk (SSD), a flash memory, a storage stick, etc.

The network module 206 may be configured to provide communication with other external devices to the electronic device 200 via a network. The network may be any wired or wireless network capable of transmitting and receiving data. For example, the network may be a wired network, a local wireless network (for example, Bluetooth, WiFi, near field communication (NFC), etc.), a cellular network, the Internet, or a combination of the above. It can be understood that the type of the network is not limited to the above specific examples. In some embodiments, the network module 306 may include any combination of any number of network interface controllers (NIC), radio frequency modules, transceivers, modems, routers, gateways, adapters, cellular network chips, etc.

The peripheral interface 208 may be configured to connect the electronic device 200 to one or more peripheral devices to achieve information input and output. For example, the peripheral devices may include input devices such as a keyboard, a mouse, a touchpad, a touchscreen, a microphone, various sensors, etc., and output devices such as a display, a speaker, a vibrator, an indicator light, etc.

The bus 210 may be configured to transmit information between components (such as the processor 202, the memory 204, the network module 206, and the peripheral interface 208) of the electronic device 200, such as an internal bus (for example, a processor-memory bus), an external bus (a USB port, a PCI-E bus), etc.

It should be noted that although the architecture of the electronic device 200 described above only shows the processor 202, the memory 204, the network module 206, the peripheral interface 208, and the bus 210, during the specific implementation process, the architecture of the electronic device 200 may also include other components necessary for normal execution. In addition, those skilled in the art can understand that the architecture of the electronic device 200 described above may also contain only components necessary for implementing the solutions of the embodiments of the present disclosure, and does not necessarily contain all the components shown in the figure.

Program development usually requires users to possess profound program expertise, such as program development frameworks, API interface invokes, etc. This process is often time-consuming and labor-intensive, resulting in a high development barrier. At present, although some program development platforms simplify the development process, they often limit the platform compatibility and functions of the program, which makes users face a lot of inconvenience when developing, debugging, and packaging program components, which affects the development efficiency. At the same time, due to technical limitations between different program platforms, users need to adapt and optimize for different platforms. This increases development workload and complexity, and also affects the cross-platform compatibility and user experience of applets. Therefore, how to improve the development efficiency and cross-platform compatibility of programs has become a technical issue that needs to be solved urgently.

In view of this, embodiments of the present disclosure provide a program generation method and related device. By acquiring a target component based on different program platforms, generating a corresponding first-type file and a corresponding second-type file based on these components, and then fusing the two types of files to generate a target program, the cross-platform program development can be realized efficiently and conveniently, the speed and efficiency of program development are improved, and the development process is simplified.

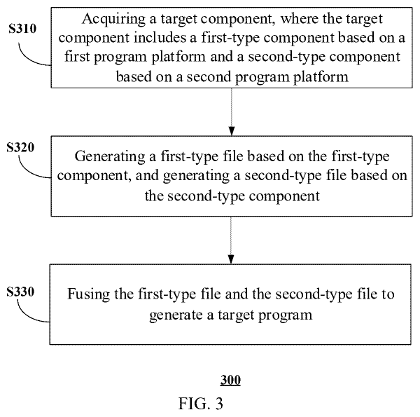

Referring to FIG. 3, FIG. 3 shows a schematic flowchart of a program generation method according to an embodiment of the present disclosure. The program generation method according to the embodiment of the present disclosure may be deployed on a terminal or a server. In FIG. 3, the program generation method 300 may further include the following steps.

In step S310, a target component is acquired, where the target component includes a first-type component based on a first program platform and a second-type component based on a second program platform.

The target component may be a user-defined component, and these components may be based on different platforms or frameworks, and used to construct an application or system. The first program platform and the second program platform may refer to two different program development platforms, for example, the first program platform may be a low-code platform, where a user can customize a component without writing a large amount of code; and the second program platform may be a no-code platform, where a component can be customized through a visual interface and pre-built modules without writing any code. The first-type component may refer to a component defined based on the first program platform, and the second-type component may refer to a component defined based on the second program platform. For example, the first program platform may be a low-code platform, and the first-type component may be a low-code component; the second program platform may be a no-code platform, and the second-type component may be a no-code component.

In some embodiments, the acquiring the target component may include: acquiring an entry file of the target component based on a traversal tool. The traversal tool may be a fast-glob module, and the fast-glob module is a fast and customizable file matching library, which can be used to match all files that meet a specific pattern in a directory. The fast-glob module is used to collect entry files of the target component, and the entry file may be a starting point of each component, for example, a .js or .jsx file.

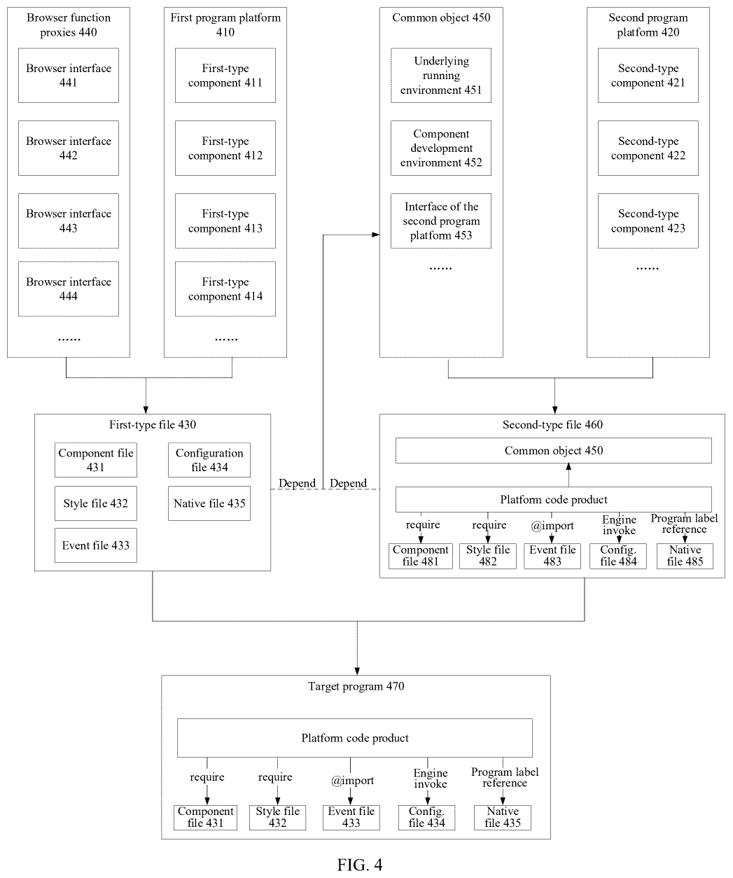

Referring to FIG. 4, FIG. 4 shows a schematic diagram of a program generation method according to an embodiment of the present disclosure. In FIG. 4, the target component may include a first-type component 411, a first-type component 412, a first-type component 413, a first-type component 414 . . . based on a first program platform 410. For example, the first-type component 411 may be a user-defined component A, the first-type component 412 may be a user-defined component B, the first-type component 413 may be an event C, and the first-type component 414 may be a native component D based on the first program platform 410. The target component may also include a second-type component 421, a second-type component 422, a second-type component 423 . . . based on a second program platform 420. For example, the second-type component 421, the second-type component 422, and the second-type component 423 may be a no-code component 1, a no-code component 2, and a no-code component 3, respectively.

In step S320, a first-type file is generated based on the first-type component, and a second-type file is generated based on the second-type component.

The first-type file may refer to a product file obtained by parsing the first-type component, and the second-type file may refer to a product file obtained by parsing the second-type component.

In some embodiments, the generating the first-type file based on the first-type component includes:
parsing the first-type component to obtain the first-type file of a preset file type, where the preset file type includes at least one of: a component file, a style file, an event file, or a configuration file.

The type of the first-type file corresponds to the preset file type. The component file may refer to a file about the main execution logic of the component, such as a JavaScript (JS) file. The style file may refer to a file about the style of the component, such as a CSS file. The event file may refer to a file that records events that occur about the component, such as errors, warnings, informational messages, or other events, etc., which may be JavaScript (JS) files. The configuration file may refer to a file about the configuration information of the component, such as a config file. The configuration file may include environment variables, etc., and may be dynamically loaded into the program through mechanisms such as environment variables. As shown in FIG. 4, the first-type file 430 may include at least one of: a component file 431, a style file 432, an event file 433, or a configuration file 434.

Specifically, a front-end tool, such as React, may be used to parse and package the first-type file. The front-end tool may parse and package one or more first-type files into output files of at least one preset file type, and may also perform optimization such as code compression and code segmentation. For example, the first-type component 411 may be parsed to obtain a corresponding configuration file, which specifies how to process the first-type component 411. For another example, the first-type component 412 may also be parsed and packaged to obtain a style file and a configuration file unique to the first-type component 412. The mini-css-extract-plugin may be used to extract CSS from the JavaScript file of the first-type component 412 and package it into a separate style file; and a specific parser may also be used to extract the configuration data and generate a corresponding configuration file. The packaged first-type file may be distributed to an appropriate directory, for example, a corresponding folder may be created, and the packaged file may be copied or moved to the folder.

In some embodiments, the first-type component is associated with a first browser interface, and parsing the first-type component to obtain the first-type file of the preset file type includes:
invoking a second browser interface encapsulated in a running environment and being the same as the first browser interface, to parse the first-type component to obtain the first-type file.

The first browser interface may refer to a browser interface that needs to be invoked by the first-type component, and the second browser interface may refer to a proxy interface of the browser interface that needs to be invoked by the first-type component. When users develop the first-type component using the front-end tool React, they may directly or indirectly invoke the first browser interface to invoke related browser functions such as BOM (Browser Object Model) or DOM (Document Object Model), such as createElement, appendChild, removeChild, etc. However, these browser functions are usually not available in the program running environment. In order to be compatible with a multi-platform running environment, the invocation of the browser function may be proxied to another implementation. Specifically, one or more browser functions may be encapsulated in the running environment, and a corresponding second browser interface may be provided, for example, the encapsulation of various browser functions in Taro Runtime may be used. Taro Runtime is a core part of the multi-terminal unified development framework Taro, which encapsulates the underlying capabilities of different running environments (such as applets, H5, etc.), enabling users to use a unified codebase to build multi-terminal applications. In combination with the configuration of build tools (such as Webpack, Rollup, etc.), browser functions may be invoked in a low code environment of the first program platform. By configuring these tools, the invocations of the first-type component to BOM/DOM may be proxied to the implementation of Taro Runtime, thereby implementing the invocation of these browser functions in a non-browser environment (such as a low code environment) such as a program. In this way, components developed using React in a multi-platform running environment may be realized, while ensuring that these components may invoke required browser functions. This helps to improve the performance and user experience of the application, and enables users to perform cross-platform program development more efficiently. As shown in FIG. 4, the browser interfaces 441-444 may be encapsulated as browser function proxies 440. When the first-type component is parsed and packaged, when the first-type component needs to invoke browser functions, the browser interfaces 441-444, etc. in the browser function proxies 440 may be directly invoked. For example, the browser interfaces 441-444 may correspond to window interfaces, document interfaces, navigate interfaces, or Element interfaces, respectively. It should be understood that the above browser interfaces 441-444 are only exemplary illustrations of the browser function proxy 440, and are not intended to limit the browser interfaces in the browser function proxy 440. The browser function proxy 440 may also include more or fewer browser interfaces, which is not limited here.

In some embodiments, the method 300 further includes:
identifying a native component of the first program platform invoked by the first-type component; and
merging the native component into the first-type file.

The native component of the first program platform may refer to a component that is directly provided by the first program platform, is native, and is not packaged by a third party or customized, such as a text box component, a button component, etc. In the development process of the first-type component, the native component provided by the first program platform may be relied on. In order to ensure that the first-type component may correctly use the native component, the native component may be declared through a configuration file. In the construction process, a syntax parser may be used to identify the native component of the first program platform invoked in the first-type component. Once the native component of the first program platform is identified, a build tool may directly package the native component into the first-type file, such as the native component 435 in the first-type file 430 shown in FIG. 4. This may ensure that the final target program may correctly load and use the native component of the first program platform when the program is running. In order to avoid conflicts between native components of different program platforms and native components of the first-type components, uniqueness processing may be performed on the names of the native components. For example, a prefix or a suffix may be added to the names of the native components to ensure that the names of each native component are unique globally. In this way, even if there are multiple native components with the same name, they may be distinguished through uniqueness processing to avoid potential conflicts and errors. In addition, in order to avoid repeated packaging and resource waste, the build tool may also optimize the native components. For example, if multiple first-type components rely on the same native component, the native component may be packaged only once, instead of being packaged separately each time. This may reduce the data volume of the first-type file and improve the loading speed and performance of the application. It can be seen that by performing uniqueness processing on the names of the native components and performing optimization and resource management in the construction process, the correct operation of the program and a good user experience may be ensured.

In some embodiments, the generating the second-type file based on the second-type component includes:
extracting a common object of the first program platform and the second program platform, where the common object includes at least one of: an underlying running environment, a component development environment, or an interface of the second program platform; and
generating the second-type file based on the common object and the second-type component.

The first program platform and the second program platform use the same technology stack, and there may be some functions shared by both parties, and these shared contents only need to be provided once in the final target program, so as to reduce code redundancy of the target program. The common object on which the first program platform and the second program platform commonly depend may be extracted by analyzing the codebase, using tools, or comparing the API provided by the first program platform and the second program platform. For example, as shown in FIG. 4, in the configuration of the build tools, an underlying running environment 451 (for example, a Taro3 base), a component development environment 452 (for example, React), and an API interface 453 provided by the second program platform (for example, a no-code platform) are extracted as a common object 450 to ensure the uniqueness of the common object. The second-type file 460 may be generated by packaging based on the common object 450 and the second-type component.

In step S330, the first-type file and the second-type file are fused to generate a target program.

The first-type file is obtained based on the first program platform, and the second-type file is obtained based on the second program platform. The first-type file and the second-type file are fused to generate the cross-platform target program. Users may use React, a front-end technology stack of the first program platform (for example, a low-code platform), to develop components, and use a command-line interface (CLI) tool of the second program platform (for example, a no-code platform) for local development, such as code debugging and building. The development, debugging, and packaging of cross-platform low-code programs may be realized, and the speed and efficiency of program development are improved.

In some embodiments, the fusing the first-type file and the second-type file to generate the target program includes:
setting a part associated with the first-type file in a compilation configuration of the second program platform as a blank file; and
replacing the blank file with a corresponding first-type file to generate the target program.

Specifically, as shown in FIG. 4, in the process of combining the first-type file 430 and the second-type file 460 to generate the target program 470, the module associated with the first-type file 430 may be set as an external dependency in a compilation configuration of the second program platform (for example, a no-code platform), and the external dependency may include at least one of a component file 481, a style file 482, an event file 483, a configuration file 484, or a native file 485. The default value of the external dependency may be set to a blank file. After the compilation of the first-type component is completed, the blank file of a corresponding type in the compilation configuration of the second program platform is replaced with the component file 431, the style file 432, the event file 433, the configuration file 434, or the native file 435 in the generated first-type file 430, so as to generate the final target program package.

In some embodiments, the replacing the blank file with the corresponding first-type file includes at least one of:
for a case where a type of the blank file is of a component file and/or an event file, replacing the blank file with the first-type file based on a JavaScript language;
for a case where the type of the blank file is of a style file, replacing the blank file with the first-type file based on a cascading style sheet;
for a case where the type of the blank file is of a configuration file, replacing the blank file with the first-type file based on a JSON file; or
for a case where the type of the blank file is of a native component, replacing the blank file with a native component in the first-type file.

Specifically, for the component file 481 and the event file 483 in the external dependency, which are both script files, the component file 431 in the first-type file 430 may be introduced to replace the component file 481, and the event file 433 in the first-type file 430 may be introduced to replace the component file 483, in the way of JavaScript language (for example, require statement of ES6 code). For the style file 482 in the external dependency, the style file 432 in the first-type file 430 may be introduced to replace the style file 482 based on a cascading style sheet (for example, @import statement of CSS). For the configuration file 484 in the external dependency, the configuration file 434 in the first-type file 430 may be introduced to replace the configuration file 484 based on a JSON file (for example, JSON file merging, engine invoking). For the native component 485 in the external dependency, the native component 435 in the first-type file 430 may be directly copied (for example, program label reference) to replace the native component 485.

In some embodiments, the method 300 may further include:
in response to a change in the first-type file, compiling the changed first-type file to obtain a first-type change compilation result; and
updating the target program based on the first-type change compilation result.

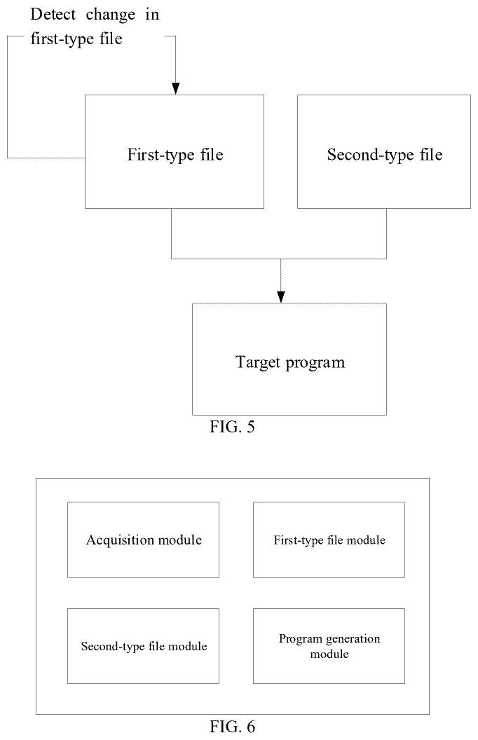

When the first-type file changes, the changed part may be recompiled, and the code merging strategy can be re-invoked to generate new target program code. Referring to FIG. 5, which shows a schematic diagram of updating a target program according to an embodiment of the present disclosure. In FIG. 5, changes in the code and configuration of the first-type file may be detected, for example, a detection mechanism may be set up to detect changes in the code and configuration files of the first-type file, so as to perform compilation and updating in time. Once a change in the code or configuration file of the first-type file is detected, the changed part of the file may be automatically recompiled, and the code merging strategy may be re-invoked. After generating new applet code, users may debug locally. This enables developers to view the impact of code changes in real time and make adjustments in time to ensure that the functions and performance of the program meet expectations.

It can be seen that the program generation method of the embodiments of the present disclosure may be based on a no-code program platform with a Taro3 base to generate a low-code program. On this no-code platform, users may build and publish no-code programs in the form of visual dragging. For components not built in the no-code platform, the CLI (command-line interface) provided by the low-code platform may be used locally to expand the capabilities of the no-code program by writing low-code, so as to realize efficient cross-platform low-code program generation and local debugging based on Taro3, improve the efficiency of program development, and smooth out differences between different program platforms.

It should be noted that the method of the embodiments of the present disclosure may be executed by a single device, such as a computer or a server. The method of this embodiment may also be applied to a distributed scenario, and be completed by multiple devices in cooperation with each other. In this distributed scenario, a device of the multiple devices may only execute one or more steps in the method of the embodiments of the present disclosure, and the multiple devices may interact with each other to complete the method.

It should be noted that some embodiments of the present disclosure are described above. Other embodiments are within the scope of the appended claims. In some cases, the actions or steps recited in the claims may be performed in an order different from that in the above embodiments and still achieve desired results. In addition, the processes depicted in the drawings do not necessarily require the specific order or continuous order shown to achieve desired results. In some implementations, multitasking and parallel processing are also possible or may be advantageous.

Based on the same technical concept, corresponding to any of the above method embodiments, the present disclosure further provides a program generation apparatus. Referring to FIG. 6, the program generation apparatus includes:
an obtaining module, configured to obtain a target component, where the target component includes a first-type component based on a first program platform and a second-type component based on a second program platform;
a first-type file module, configured to generate a first-type file based on the first-type component;
a second-type file module, configured to generate a second-type file based on the second-type component; and
a program generation module, configured to fuse the first-type file and the second-type file to generate a target program.

For the convenience of description, when describing the above apparatus, various modules are described separately according to functions. Certainly, when implementing the present disclosure, the functions of the modules may be implemented in the same or multiple software and/or hardware.

The apparatus of the above embodiments is used to implement the corresponding program generation method in any of the foregoing embodiments, and has the beneficial effects of the corresponding method embodiments, which will not be repeated here.

Based on the same technical concept, corresponding to any of the above method embodiments, the present disclosure further provides a non-transitory computer-readable storage medium. The non-transitory computer-readable storage medium stores computer instructions, and the computer instructions are used to cause the computer to execute the program generation method according to any of the above embodiments.

The computer-readable medium in this embodiment includes non-transitory and transitory, and movable and non-movable media, which may achieve information storage by any method or technology. The information may be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disc read-only memory (CD-ROM), digital versatile disc (DVD) or other optical storage, magnetic cassette, magnetic tape magnetic disk storage or other magnetic storage devices, or any other non-transmission medium, which may be used to store information that may be accessed by a computing device.

The computer instructions stored in the storage medium of the above embodiments are used to cause the computer to execute the program generation method according to any of the above embodiments, and have the beneficial effects of the corresponding method embodiments, which will not be repeated here.

Those of ordinary skill in the art should understand that the discussion of any of the above embodiments is only exemplary, and is not intended to imply that the scope of the present disclosure (including the claims) is limited to these examples. Under the idea of the present disclosure, the technical features in the above embodiments or different embodiments may also be combined, and the steps may be implemented in any order. There are many other changes in different aspects of the embodiments of the present disclosure as described above, which are not provided in detail for the sake of brevity.

In addition, in order to simplify the description and discussion, and in order not to make the embodiments of the present disclosure difficult to understand, the well-known power supply/ground connection with integrated circuit (IC) chips and other components may or may not be shown in the provided drawings. In addition, the apparatus may be shown in the form of a block diagram, so as to avoid making the embodiments of the present disclosure difficult to understand, and this also takes into account the fact that the details of the implementations of these block diagram apparatus are highly dependent on the platform on which the embodiments of the present disclosure are to be implemented (that is, these details should be entirely within the understanding of those skilled in the art). In the case where specific details (for example, circuits) are set forth to describe exemplary embodiments of the present disclosure, it is obvious to those skilled in the art that the embodiments of the present disclosure may be implemented without these specific details or with changes in these specific details. Therefore, these descriptions should be considered as illustrative rather than restrictive.

Although the present disclosure has been described in combination with specific embodiments of the present disclosure, many alternatives, modifications, and variations of these embodiments will be obvious to those of ordinary skill in the art according to the foregoing description. For example, other memory architectures (for example, dynamic RAM (DRAM)) may use the discussed embodiments.

The embodiments of the present disclosure are intended to cover all such alternatives, modifications, and variations that fall within the broad scope of the appended claims. Therefore, any omission, modification, equivalent substitution, improvement, etc. made within the spirit and principles of the embodiments of the present disclosure shall be included in the protection scope of the present disclosure.

What is claimed is:

1. A program generation method, comprising:
acquiring a target component, wherein the target component comprises a first-type component based on a first program platform and a second-type component based on a second program platform;
generating a first-type file based on the first-type component, and generating a second-type file based on the second-type component; and
fusing the first-type file and the second-type file to generate a target program.

2. The method according to claim 1, wherein generating the first-type file based on the first-type component comprises:
parsing the first-type component to obtain the first-type file of a preset file type, wherein the preset file type comprises at least one of: a component file, a style file, an event file, or a configuration file.

3. The method according to claim 2, wherein the first-type component is associated with a first browser interface, and
parsing the first-type component to obtain the first-type file of the preset file type comprises:
invoking, in a running environment, a second browser interface which is a same as the first browser interface, to parse the first-type component to obtain the first-type file.

4. The method according to claim 2, further comprising:
identifying a native component of the first program platform invoked by the first-type component; and
merging the native component into the first-type file.

5. The method according to claim 1, wherein generating the second-type file based on the second-type component comprises:
extracting a common object of the first program platform and the second program platform, wherein the common object comprises at least one of: an underlying running environment, a component development environment, or an interface of the second program platform; and
generating the second-type file based on the common object and the second-type component.

6. The method according to claim 1, wherein fusing the first-type file and the second-type file to generate the target program comprises:
setting a part associated with the first-type file in a compilation configuration of the second program platform as a blank file; and
replacing the blank file with a corresponding first-type file to generate the target program.

7. The method according to claim 6, wherein replacing the blank file with the corresponding first-type file comprises at least one of:
for a case wherein a type of the blank file is of a component file and/or an event file, replacing the blank file with the first-type file based on a JavaScript language;
for a case wherein the type of the blank file is of a style file, replacing the blank file with the first-type file based on a cascading style sheet;
for a case wherein the type of the blank file is of a configuration file, replacing the blank file with the first-type file based on a JSON file; or
for a case wherein the type of the blank file is of a native component, replacing the blank file with the native component in the first-type file.

8. The method according to claim 1, further comprising:
in response to a change in the first-type file, compiling a changed first-type file to obtain a first-type change compilation result; and
updating the target program based on the first-type change compilation result.

9. An electronic device, comprising a memory, a processor, and a computer program stored on the memory and executable on the processor, wherein the processor, when executing the program, performs a program generation method, comprising:
acquiring a target component, wherein the target component comprises a first-type component based on a first program platform and a second-type component based on a second program platform;
generating a first-type file based on the first-type component, and generating a second-type file based on the second-type component; and
fusing the first-type file and the second-type file to generate a target program.

10. The electronic device according to claim 9, wherein generating the first-type file based on the first-type component comprises:
parsing the first-type component to obtain the first-type file of a preset file type, wherein the preset file type comprises at least one of: a component file, a style file, an event file, or a configuration file.

11. The electronic device according to claim 10, wherein the first-type component is associated with a first browser interface, and
parsing the first-type component to obtain the first-type file of the preset file type comprises:
invoking, in a running environment, a second browser interface which is a same as the first browser interface, to parse the first-type component to obtain the first-type file.

12. The electronic device according to claim 10, further comprising:
identifying a native component of the first program platform invoked by the first-type component; and
merging the native component into the first-type file.

13. The electronic device according to claim 9, wherein generating the second-type file based on the second-type component comprises:
extracting a common object of the first program platform and the second program platform, wherein the common object comprises at least one of: an underlying running environment, a component development environment, or an interface of the second program platform; and
generating the second-type file based on the common object and the second-type component.

14. The electronic device according to claim 9, wherein fusing the first-type file and the second-type file to generate the target program comprises:
setting a part associated with the first-type file in a compilation configuration of the second program platform as a blank file; and
replacing the blank file with a corresponding first-type file to generate the target program.

15. The electronic device according to claim 14, wherein replacing the blank file with the corresponding first-type file comprises at least one of:
for a case wherein a type of the blank file is of a component file and/or an event file, replacing the blank file with the first-type file based on a JavaScript language;
for a case wherein the type of the blank file is of a style file, replacing the blank file with the first-type file based on a cascading style sheet;
for a case wherein the type of the blank file is of a configuration file, replacing the blank file with the first-type file based on a JSON file; or
for a case wherein the type of the blank file is of a native component, replacing the blank file with the native component in the first-type file.

16. The electronic device according to claim 9, further comprising:
in response to a change in the first-type file, compiling a changed first-type file to obtain a first-type change compilation result; and
updating the target program based on the first-type change compilation result.

17. A non-transitory computer-readable storage medium storing computer instructions, wherein the computer instructions are used to cause a computer to perform a program generation method, comprising:
acquiring a target component, wherein the target component comprises a first-type component based on a first program platform and a second-type component based on a second program platform;
generating a first-type file based on the first-type component, and generating a second-type file based on the second-type component; and
fusing the first-type file and the second-type file to generate a target program.

18. The computer-readable storage medium according to claim 17, wherein generating the first-type file based on the first-type component comprises:
parsing the first-type component to obtain the first-type file of a preset file type, wherein the preset file type comprises at least one of: a component file, a style file, an event file, or a configuration file.

19. The computer-readable storage medium according to claim 18, wherein the first-type component is associated with a first browser interface, and
parsing the first-type component to obtain the first-type file of the preset file type comprises:
invoking, in a running environment, a second browser interface which is a same as the first browser interface, to parse the first-type component to obtain the first-type file.

20. The computer-readable storage medium according to claim 18, further comprising:
identifying a native component of the first program platform invoked by the first-type component; and
merging the native component into the first-type file.
